(19) United States
(12) Patent Application Publication
(10) Pub. No.: US 2006/0290820 A1
(43) Pub. Date: Dec. 28, 2006

(54) BRIGHTNESS CONTROL DEVICE AND METHOD FOR CRT DISPLAY UNIT AND CRT DISPLAY UNIT UTILIZING THE SAME

(75) Inventor: Yu-Hsiao Wu, Nantou County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan (TW)

(21) Appl. No.: 11/425,458

(22) Filed: Jun. 21, 2006

(30) Foreign Application Priority Data
Jun. 27, 2005 (TW) 94121407

(51) Int. Cl. H04N 9/73

(52) U.S. Cl. 348/687; 348/655

(57) ABSTRACT

A CRT display unit with a brightness control device is provided. The brightness control comprises a main control unit generating a brightness signal controlling brightness of the display unit and a first auto brightness limit (ABL) signal according to a brightness parameter; and an offset module receiving the brightness and first ABL signals, and offsetting the first ABL signal according to the brightness signal to generate a second ABL signal keeping a ABL brightness of the display unit from being affected by the brightness parameter.

### BACKGROUND

The invention is related to cathode ray tube (CRT) display and, more particularly, to a method and device of brightness control for a cathode ray tube (CRT) display unit and a CRT display unit utilizing the same.

White balance of a CRT display unit comprises adjustment of raster frame brightness, 3-inch block brightness and auto bright limit (ABL) frame brightness. The raster frame brightness is set to a cut-off condition, when the 3-inch block brightness and ABL frame brightness are being modified. When a brightness parameter is adjusted to maximum, the raster frame brightness is increased (e.g. from lower than 0.1 Ft-L to 0.5˜1.5 Ft-L), such that ABL frame brightness is increased. In general, every 1-Ft-L increase of the ABL frame brightness leads to a 0.5 W power consumption increase of the CRT display unit. Adjustment of the brightness parameter affects the ABL frame brightness and power consumption of the CRT display unit, accordingly.

FIG. 1 illustrates a circuit block diagram of a conventional CRT display unit 10. CRT display unit 10 comprises a CRT 101 and a brightness control device 102. In brightness control device 102, main control unit (MCU) 102a generates a brightness signal S_{br} and auto brightness limit (ABL) signal S_{ABL}_{_{—}}_{PWM} controlling brightness of the CRT, according to a brightness parameter. An ABL compensator 102c receives the ABL signal S_{ABL}_{_{—}}_{PWM} and outputs signals to an image controller 102d and a fly-back transformer 102e to control related display functions of the display unit 10. For example, image controller 102d can control a beam current of CRT 101.

As described, ABL frame brightness can still increase with brightness signal S_{br} (or brightness parameter), even when voltage level of the ABL signal S_{ABL}_{_{—}}_{PWM} is fixed.

Conventionally, when setting up CRT display units during manufacturing, such as processing white balance or geometry adjustment, raster frame brightness is set to a cut-off condition. However, when testing samples in the final examination or quality check (QC) stage of manufacturing, a power consumption is tested by setting the brightness to maximum, such that power consumption of CRT display units may exceed specifications.

FIG. 2 illustrates a conventional circuit for brightness compensation. The circuit is complicated, consumes more layout space and cost, and may affect vertical/horizontal adjustment when adjusting the compensation of the ABL frame brightness.

A scheme for compensation of the ABL frame brightness is required to maintain power consumption of CRT display units within specifications when testing samples.

### SUMMARY

The invention provides a CRT display unit, utilizing devices and methods of brightness control to generate an ABL signal that decreases as brightness parameter increases, such that the ABL frame brightness and power consumption of CRT display unit do not increase with brightness parameters.

The invention provides A brightness control device for a display unit, comprsing a main control unit generating a brightness signal controlling brightness of the display unit and a first auto brightness limit (ABL) signal according to a brightness parameter, and an offset module receiving the brightness and first ABL signals and offsetting the first ABL signal according to the brightness signal to generate a second ABL signal keeping a ABL brightness of the display unit from being affected by the brightness parameter.

The invention further provides a CRT display unit comprising a CRT, and a brightness control device comprising a main control unit generating a brightness signal controlling brightness of the display unit and a first ABL signal according to a brightness parameter, an offset module receiving the brightness and first ABL signals, and offsetting the first ABL signal according to the brightness signal to generate a second ABL signal controlling a ABL brightness of the display unit from increased with the brightness parameter, an ABL compensator receiving the second ABL signal and outputting a first and second control signal, an image controller receiving the first control signal and controlling a beam current of the cathode ray tube (CRT) of the display unit, and a fly-back transformer receiving the second control signal and controlling related display functions of the display unit.

The invention further provides a method of brightness control for a display unit comprising a main control unit generating a brightness signal controlling brightness of the CRT and a first ABL signal according to a brightness parameter. The method comprises detecting the brightness signal receiving the brightness and first ABL signals, offsetting the first ABL signal according to the brightness signal; and using the second ABL signal to maintain an ABL brightness of the display unit as brightness parameters increase.

### DESCRIPTION OF THE DRAWINGS

The accompanying drawings, incorporated in and constituting a part of this specification, illustrate embodiments of the invention and, together with the description, serve to explain the features, advantages, and principles of the invention.

FIG. 1 is a circuit block diagram of a conventional CRT display unit.

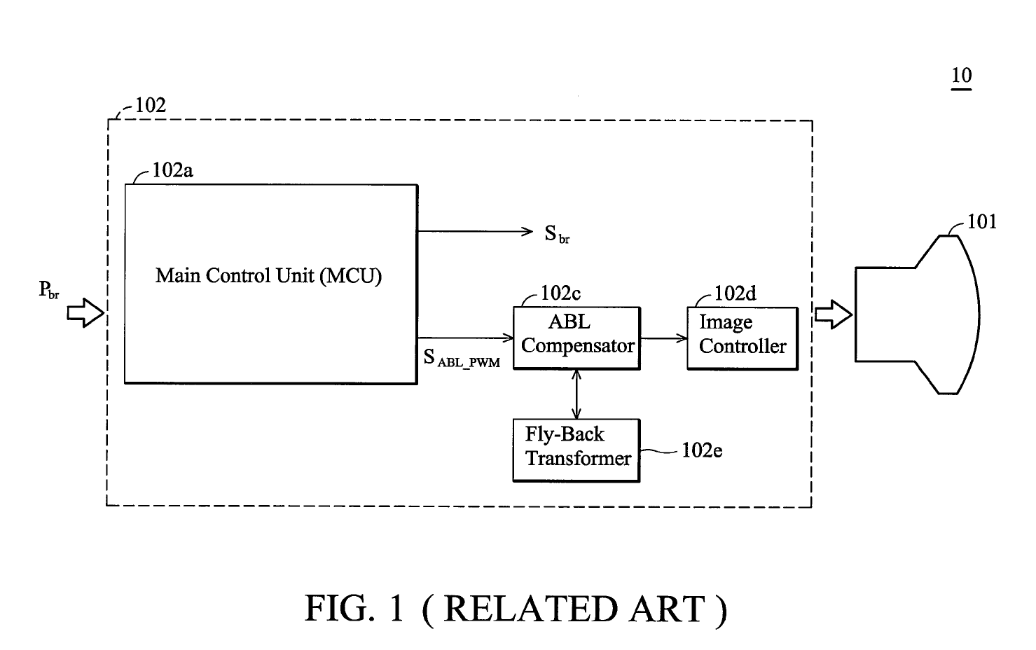

FIG. 2 illustrates a conventional circuit for brightness compensation.

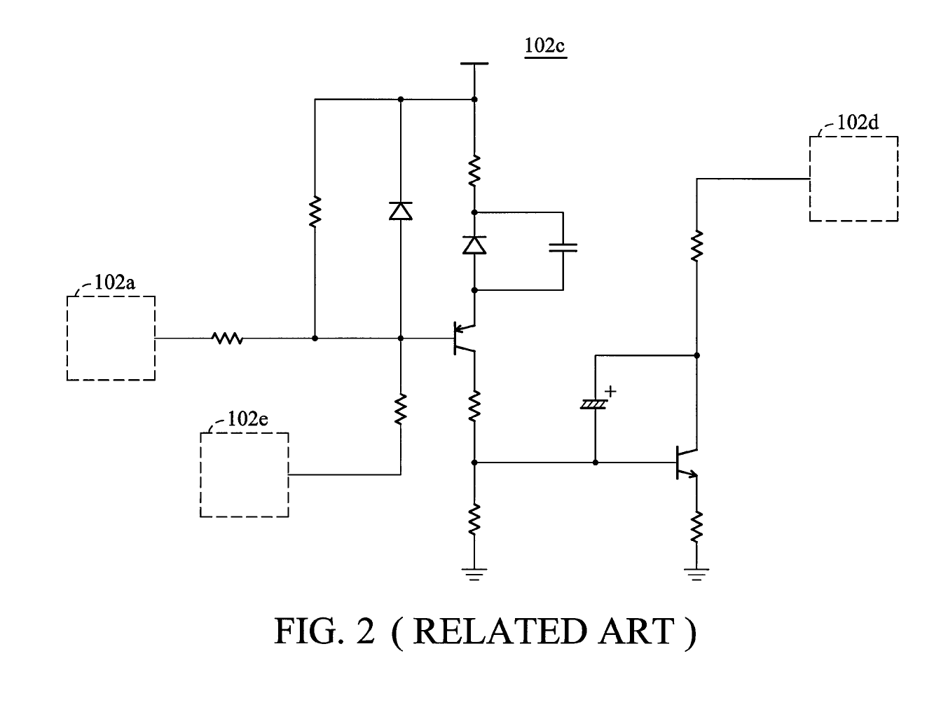

FIG. 3 is a flowchart of a method of brightness control for CRT display units according to an embodiment of the invention.

FIG. 4 is a block diagram of a CRT display unit of an embodiment of the invention.

FIG. 5 is a circuit block diagram of an embodiment of brightness control unit 302 of FIG. 4.

### DETAILED DESCRIPTION

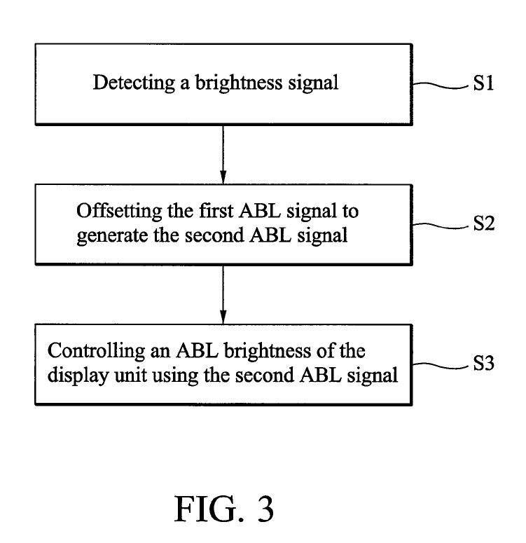

FIG. 3 is a flowchart of a method of brightness control for CRT display units according to an embodiment of the invention. A CRT display unit adaptable to the method comprises at least a main control unit generating a brightness signal controlling brightness of the CRT and a first ABL signal according to a brightness parameter. The method of brightness control for CRT display units comprises the following steps.

First, brightness signal is detected (Step S1). The brightness and first ABL signals then are received, and the first ABL signal is offset according to the brightness signal (Step S2). The second ABL signal is used to keep an ABL brightness of the display unit (Step S3) from being increased with brightness parameter. In this embodiment, even when brightness parameter is set to maximum during testing, power consumption does not exceed specifications of the CRT display or QC testers.

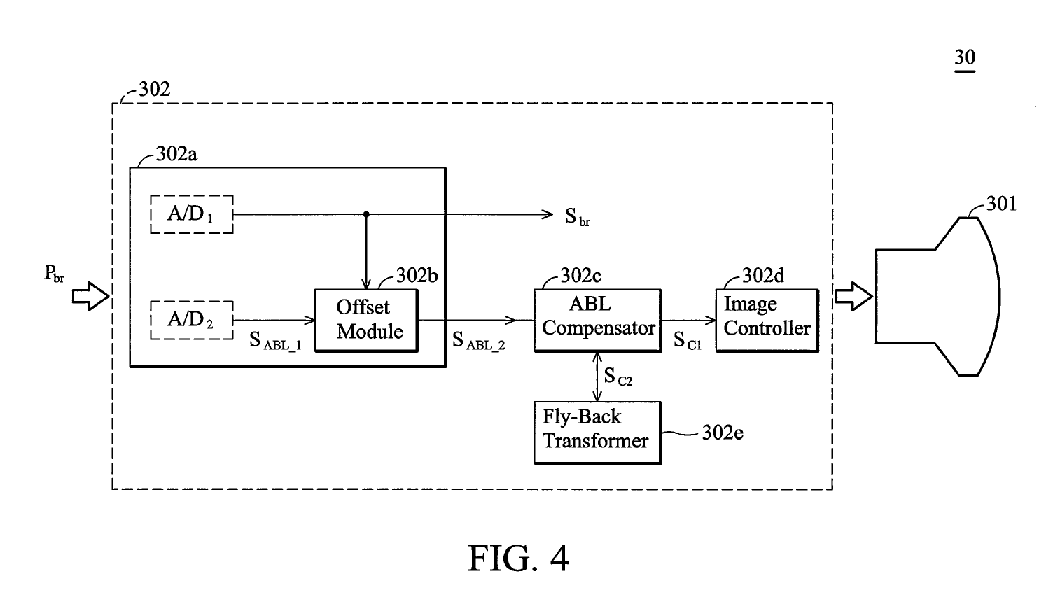

FIG. 4 is a block diagram of a CRT display unit of an embodiment of the invention, implemented with the described method.

CRT display unit 30 comprises a CRT 301 and a brightness control device 302. The brightness control device 302 comprises at least a main control unit 302a and a offset module 302b. Main control unit 302a generates a brightness signal S_{br} controlling brightness of the CRT display unit 301 and a first ABL signal S_{ABL}_{_{—}}₁ according to a brightness parameter P_{br}. Offset module 302b receives the brightness and first ABL signals S_{br} and S_{ABL}_{_{—}}₁, and offsets the first ABL signal S_{ABL}_{_{—}}₁ according to the brightness signal S_{b} to generate a second ABL signal S_{ABL}_{_{—}}₂ keeping a ABL brightness of the CRT display unit 301 from being increased with brightness parameter P_{br}.

Offset module 302b generates an offset value S_{off} (not shown in FIG. 4) according to the brightness signal S_{b} and generates the second ABL signal S_{ABL}_{_{—}}₂ by subtracting the offset value S_{off} from the first ABL signal S_{ABL}_{_{—}}₁. The offset value S_{off} can be acquired by multiplying the brightness signal S_{b} with a predetermined ratio.

In this embodiment, brightness parameter P_{br} can be delivered by an analog or digital signal. For example, when brightness parameter P_{br} is an analog signal, after receiving brightness parameter P_{br}, main control unit 302a utilizes built-in analog-to-digital converters A/D₁ and A/D₂ to generate brightness signal S_{br} and first ABL signal S_{ABL}_{_{—}}₁. Offset value S_{off} is acquired according to brightness signal S_{br}:

$$Soff = [ word \times ( {S}_{br} - C ) ] \times ( \frac{A}{B} ) .$$

First ABL signal S_{ABL}_{_{—}}₁ is then offset to generate a second ABL signal S_{ABL}_{_{—}}₂ according to value [S_{ABL}_{_{—}}₁−S_{off}], wherein A and B are constants, “word” is data bit length used by main control unit 302a and C is a brightness threshold. For example, if brightness is 256°, C can be set to 77 when offset is required after brightness exceed 30%.

CRT display unit in FIG. 4 further comprises an ABL compensator 302c receiving the second ABL signal S_{ABL}_{_{—}}₂ and outputting first and second control signals S_{C1} and S_{C2}; an image controller 302d receiving the first control signal S_{C1} and controlling a beam current of the CRT 301; and a fly-back transformer 302e receiving the second control signal S_{C2} and controlling related display functions of the display unit.

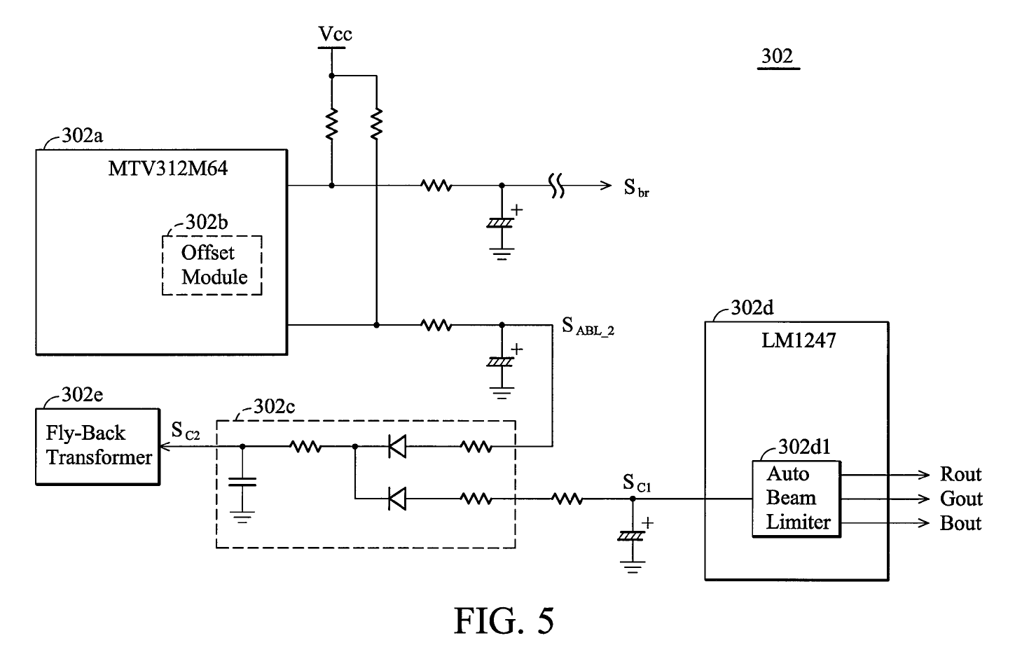

FIG. 5 is a circuit block diagram of an embodiment of brightness control unit 302 of FIG. 4. In this embodiment, main control unit 302a is a microcontroller IC, such as IC MTV312M64 manufactured by Myson technology. Image is an IC such as IC LM1247 manufactured by National Semiconductor. IC LM1247 comprises an auto beam limiter 302d1 receiving first control signal S_{C1} and output Rₒᵤₜ, Gₒᵤₜ and Bₒᵤₜ signal to control the beam current of the CRT 301.

Additionally, in FIG. 5, offset module 302b is implemented internally in main control unit 302a, in a form such as a software module to process the offset function. Offset module 302b can also be implemented as a hardware circuit external to the main control unit 302a.

Table 1 lists relationships between brightness parameter and power consumption without offsetting the S_{ABL}_{_{—}}₁ signal.

TABLE 1

| Brightness | ABL frame | S_{ABL}_{_{—}}1 | power |
|---|---|---|---|
| Parameter | Brightness | Voltage | consumption |
| 0 | 28.2 | 3.78 | 72.2 |
| 30(cut-off) | 30.0 | 3.78 | 73.1 |
| 40 | 30.4 | 3.78 | 73.3 |
| 50 | 31.3 | 3.78 | 73.8 |
| 60 | 32.2 | 3.78 | 74.2 |
| 70 | 33.2 | 3.78 | 74.7 |
| 80 | 33.6 | 3.78 | 74.9 |
| 90 | 34.0 | 3.78 | 75.1 |
| 100(max) | 34.5 | 3.78 | 75.4 |

Table 2 lists relationships between brightness parameter and power consumption with the S_{ABL}_{_{—}}₁ signal offset.

TABLE 2

| Brightness | ABL frame | S_{ABL}_{_{—}}2 | power |
|---|---|---|---|
| Parameter | Brightness | Voltage | consumption |
| 0 | 28.2 | 3.78 | 72.2 |
| 30(cut-off) | 30.0 | 3.64 | 73.1 |
| 40 | 30.0 | 3.62 | 73.1 |
| 50 | 30.0 | 3.58 | 73.1 |
| 60 | 30.0 | 3.54 | 73.1 |
| 70 | 30.0 | 3.50 | 73.1 |
| 80 | 30.0 | 3.46 | 73.1 |
| 90 | 30.0 | 3.43 | 73.1 |
| 100(max) | 30.0 | 3.39 | 73.1 |

Referring to Table 1, when brightness parameter is raised, because voltage level of first ABL signal S_{ABL}_{_{—}}₁ of main control unit remains at 3.78V and ABL frame brightness (in Ft-L) increases commensurately, power consumption of the CRT display increases accordingly.

Referring further to Table 2, when brightness parameter is raised, because voltage level of second ABL signal S_{ABL}_{_{—}}₂ offset from first ABL signal S_{ABL}_{_{—}}₁ decreases commensurately, ABL frame brightness (in Ft-L) does not increase commensurately, such that the power consumption of the CRT display does not increase commensurately.

While the invention has been described by way of example and in terms of preferred embodiment, it is to be understood that the invention is not limited thereto. Those skilled in the technology can still make various alterations and modifications without departing from the scope and spirit of this invention. Therefore, the scope of the present invention shall be defined and protected by the following claims and their equivalents.

What is claimed is:

1. A brightness control device for a display unit, comprsing:
a main control unit generating a brightness signal controlling brightness of the display unit and a first auto brightness limit (ABL) signal according to a brightness parameter; and
an offset module receiving the brightness and first ABL signals, and offsetting the first ABL signal according to the brightness signal to generate a second ABL signal keeping a ABL brightness of the display unit from being affected by the brightness parameter.

2. The brightness control device as claimed in claim 1, further comprising:
an ABL compensator receiving the second ABL signal and outputting first and second control signals;
an image controller receiving the first control signal and controlling a beam current of a cathode ray tube (CRT) of the display unit; and
a fly-back transformer receiving the second control signal and controlling related display functions of the display unit.

3. The brightness control device as claimed in claim 1, wherein the offset module generates an offset value according to the brightness signal and generates the second ABL signal by subtracting the offset value from the first ABL signal.

4. The brightness control device as claimed in claim 3, wherein the offset value equals the product of the brightness signal and a predetermined ratio.

5. The brightness control device as claimed in claim 3, wherein the main control unit is a microcontroller controlling operations of the offset module.

6. The brightness control device as claimed in claim 2, wherein the image controller comprises an auto beam limiter receiving the first control signal.

7. A CRT display unit comprising:
a CRT; and
a brightness control device comprsing:
a main control unit generating a brightness signal controlling brightness of the display unit and a first ABL signal according to a brightness parameter;
an offset module receiving the brightness and first ABL signals, and offsetting the first ABL signal according to the brightness signal to generate a second ABL signal keeping a ABL brightness of the display unit from being increased with brightness parameter;
an ABL compensator receiving the second ABL signal and outputting first and second control signals;
an image controller receiving the first control signal and controlling a beam current of the cathode ray tube (CRT) of the display unit; and
a fly-back transformer receiving the second control signal and controlling related display functions of the display unit.

8. The CRT display unit as claimed in claim 7, wherein the offset module generates an offset value according to the brightness signal and generates the second ABL signal by subtracting the offset value from the first ABL signal.

9. The CRT display unit as claimed in claim 8, wherein the offset value equals the product of the brightness signal and a predetermined ratio.

10. The CRT display unit as claimed in claim 8, wherein the main control unit is a microcontroller controlling operations of the offset module.

11. The CRT display unit as claimed in claim 8, wherein the image controller comprises an auto beam limiter receiving the first control signal.

12. A method of brightness control for a display unit comprising a main control unit generating a brightness signal controlling brightness of the CRT and a first ABL signal according to a brightness parameter; wherein the method comprises:
detecting the brightness signal;
receiving the brightness and first ABL signals, and offsetting the first ABL signal according to the brightness signal; and
using the second ABL signal to keep an ABL brightness of the display unit from being increased with brightness parameter.

13. The method as claimed in claim 12, further comprising generating an offset value according to the brightness signal and generates the second ABL signal by subtracting the offset value from the first ABL signal.

14. The method as claimed in claim 13, wherein the offset value equals to the product of the brightness signal and a predetermined ratio.
